(19) United States
(12) Patent Application Publication
(10) Pub. No.: US 2007/0288546 A1
(43) Pub. Date: Dec. 13, 2007

(54) GROUPWISE COLLABORATIVE SUGGESTION MODERATION SYSTEM

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/772,808

(22) Filed: Jul. 2, 2007

Related U.S. Application Data
(63) Continuation-in-part of application No. 11/223,368, filed on Sep. 9, 2005.
(63) Continuation-in-part of application No. 11/610,615, filed on Dec. 14, 2006.
(60) Provisional application No. 60/842,256, filed on Sep. 5, 2006.
(60) Provisional application No. 60/644,417, filed on Jan. 15, 2005.
(60) Provisional application No. 60/793,214, filed on Apr. 19, 2006.

(51) Int. Cl. G06F 15/16

(52) U.S. Cl. 709/201

(57) ABSTRACT

An automated suggestion moderation system is provided that enables a group of users of portable computing devices to collaboratively pose suggestions and make decisions with the support of a software-moderated process. In one embodiment a user of a first portable computing device enters a suggestion into a user interface of the device. A representation of the suggestion is conveyed over a communication link to one or more other portable computing devices. A representation of the suggestion is displayed to a user of each respective portable computing device. A response to the suggestion is accepted from a user of each respective portable computing devices, the response indicating a level of acceptance or rejection of the posed suggestion. A software process receives the responses, tallies the responses, and generates a resulting decision; an indication of the decision is sent to and displayed on one or more of the portable computing devices.

This application claims the benefit of U.S. Provisional Patent Application No. 60/842,256 filed Sep. 5, 2006, which is incorporated in its entirety herein by reference.

This application is a continuation-in-part of U.S. patent application Ser. No. 11/223,368 filed Sep. 9, 2005, which claims the benefit of U.S. Provisional Patent Application No. 60/644,417 filed Jan. 15, 2005, both of which are incorporated in their entirety herein by reference.

This application is also a continuation-in-part of U.S. patent application Ser. No. 11/610,615 filed Dec. 14, 2006, which claims the benefit of U.S. Provisional Patent Application No. 60/793,214 filed Apr. 19, 2006, both of which are incorporated in their entirety herein by reference.

This application is also related to U.S. patent application Ser. No. 11/267,079 filed Nov. 3, 2005, which claims the benefit of U.S. Provisional Patent Application No. 60/648,197 filed Jan. 27, 2005 and U.S. Provisional Patent Application No. 60/ 665,291 filed Mar. 26, 2005, all of which are incorporated in their entirety herein by reference.

This application is also related to U.S. patent application Ser. No. 11/285,534 filed Nov. 22, 2005, which claims the benefit of the above-referenced U.S. Provisional Patent Application Nos. 60/648,197 and 60/665,291, and which also claims the benefit of U.S. Provisional Patent Application No. 60/651,771 filed Feb. 9, 2005, all of which are incorporated in their entirety herein by reference.

This application is also related to U.S. patent application Ser. No. 11/533,037 filed Sep. 19, 2006, which is a continuation-in-part of the above-referenced U.S. patent application Ser. Nos. 11/223,368 and 11/285,534, and which also claims the benefit of U.S. Provisional Patent Application No. 60/720,071 filed Sep. 23, 2005, all of which are incorporated in their entirety herein by reference.

This application is also related to U.S. patent application Ser. No. 11/749,134 filed May 15, 2007, which is incorporated in its entirety herein by reference.

### BACKGROUND OF THE INVENTION

1. Field of the Invention

The present invention relates generally to portable computing devices and, more specifically, to systems and methods for communication between a plurality of portable computing devices.

2. Discussion of the Related Art

Portable computing devices, such as cell phones, personal digital assistants, and portable media players have become popular personal devices due to their highly portable nature, their ability to provide accessibility to a large library of stored media files, their interconnectivity with existing computer networks, and their ability to pass information to other portable computing devices through WiFi networks and/or through local spontaneous networks such as Bluetooth networks. Many of these devices also provide the ability to store and display media, such as songs, videos, podcasts, ebooks, maps, and other related content and/or programming. Many of these devices are also used as navigation tools, including GPS functionality. Many of these devices are also used as personal communication devices, enabling phone, text, picture, and video communication with other similar portable devices. As a result, the general social trend within industrial societies is that every person does now or soon will maintain at least one such multi-purpose electronic device upon their person at most times, especially when out and about.

While such portable computing devices allow person to person communication, they by and large do not provide any unique tools and infrastructure that specifically enable groups of electronically networked individuals to more easily make collaborative decisions. Such features and functions would be highly beneficial, especially among groups of friends who are traveling together and making collaborative plans. In fact, the primary prior work that does enable groups of individual portable computing device users to make more easily make collaborative decisions is described in the above-referenced U.S. patent application Ser. No. 11/223,368 and U.S. Provisional Patent Application No. 60/644,417 both of which have been incorporated in their entirety herein by reference. These prior applications describe a system which enables groups of users to collaboratively select media items for collective play upon their portable computing devices. Thus, excluding this prior work, there is a substantial need to provide tools and methods by which groups of individuals, especially groups of friends who are traveling together and each have a portable computing device upon their persons, to more easily make collaborative decisions.

### SUMMARY OF THE INVENTION

Several embodiments of the invention advantageously address the needs above as well as other needs by providing systems and methods for users of portable computing devices to make collaborative decisions.

In some embodiments, the invention can be characterized as a suggestion moderation system comprising a plurality of portable computing devices, a first one of the plurality of portable computing devices adapted to send an indication of a suggestion to one or more others of the plurality of portable computing devices, each of the one or more others adapted to receive the indication of the suggestion and send respective indications of responses to a processor in response to the suggestion, wherein the processor is adapted to receive the respective indications of responses, generate an indication of a decision based at least in part upon the respective responses, and send the indication of the decision to the plurality of portable computing devices, the processor comprised within one or more of the plurality of portable computing devices or one or more external servers.

In some embodiments, the invention can be characterized as a method of moderating a suggestion comprising sending an indication of a suggestion from a first one of a plurality of portable computing devices to one or more others of the plurality of portable computing devices; receiving the indication of the suggestion at the one or more others of the plurality of portable computing devices; sending respective indications of responses to the suggestion from the one or more others of the plurality of portable computing devices to a processor, the processor comprised within one or more of the plurality of portable computing devices or one or more external servers; receiving the respective indications of responses at the processor; generating an indication of a decision based at least in part upon the respective responses; and sending the indication of the decision to the plurality of portable computing devices.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 depicts a block diagram of a portable computing device in accordance with some embodiments of the present invention;

FIG. 2 depicts a plurality of portable computing devices collaborating over an intervening network in accordance with some embodiments of the present invention;

FIG. 3 depicts a flow chart of a process in accordance with some embodiments of the present invention;

FIG. 4 depicts a display screen on a portable computing device, the display screen showing how a posed suggestion may appear to a user, in accordance with some embodiments of the present invention;

FIG. 5 depicts a display screen on a portable computing device, the display screen showing how an accepted suggestion may appear to a user, in accordance with some embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Some embodiments of the present invention address the needs above by providing systems and methods for users of portable computing devices to make collaborative decisions. Furthermore, it addresses a need to provide tools and methods that enable groups of users to better keep track of their collaborative decisions, to better keep track of which user suggested items that were collaboratively accepted or rejected by the group, and to better keep track of which users approved or rejected various suggestions that were posed to the group by other users. The present invention, as described herein, addresses these and other deficiencies present in the prior art.

Some embodiments of the present invention include methods, apparatus, and computer program products that enable a group of individual portable computing device users to more easily make and evaluate suggestions posed to the group. Some embodiments of the present invention comprise a plurality of portable computing devices, each of said devices being used by an individual user, each of the portable computing devices enabling its user to pose a suggestion to the group and/or accept or reject a suggestion posed by another member of the group. Some embodiments of the present invention also include methods and apparatus by which the acceptances and/or rejections posed provided by each individual member of the group are tallied and a collaborative decision is made as to whether or not the suggestion has been accepted or rejected by the group. A variety of inventive methods are disclosed to tallying and/or otherwise determining based upon the acceptance and/or rejection feedback provided by the group, whether or not the suggestion was collaboratively accepted or rejected. A variety of inventive methods are also disclosed for tracking each group member's success rate in posing suggestions to the group (i.e. how often that user's suggestions are accepted collaboratively by the group). A variety of inventive methods are also disclosed for tracking each groups members accuracy in responding to suggestions posed by others (i.e. how often that user's response to a suggestion matches the computed consensus of the whole group). In these ways, some embodiments of the present invention provide beneficial features and functions that enable groups of users to more easily make suggestions to the group and collaboratively accept or reject the suggestions.

This present disclosure addresses the deficiencies of the relevant art by providing exemplary systematic, methodic and computer program product embodiments which provide a Groupwise Collaborative Suggestion Moderation System that enables the members of a group of individual users of networked portable computing devices to more easily make collaborative decisions about suggestions that are posed by members of the group. More specifically, some embodiments of the present invention comprise a plurality of networked portable computing devices, each of said devices being used by an individual user, each of the portable computing devices enabling its user to pose a suggestion to the group as a textual, verbal, pictorial, and/or video representation. The present invention furthermore enables each member of the group to selectively accept or reject the suggestion posed by another member of the group. In some embodiments the acceptance or rejection is a binary decision entered by the user into his or her portable computing device. In other embodiments the acceptance or rejection is a scaled response on a subjective rating scale, the scaled response being entered by the user into his or her portable computing device. In some embodiments the user enters responses manually into his or her portable computing device. In some embodiments the user enters responses verbally into his or her portable computing device. In some embodiments the user enters responses gesturally into his or her portable computing device. In these ways a first user within a group of users or networked portable computing devices may selectively provide a suggestion to the other users of said group, said other users of said group then may selectively enter an indication of acceptance or rejection the suggestion into his or her portable computing devices.

The indications of acceptance or rejection are passed over an intervening electronic network to at least one processor, optionally a processor of one of the portable computing devices, such that a tally is compiled as to the level of acceptance and/or rejection collaboratively provided by the plurality of group members. Some embodiments of the present invention also include methods and apparatus by which a final collaborative decision is made as to whether or not the suggestion has been accepted or rejected by the group. In the most common embodiments, an indication as to state of the collaborative decision is then communicated to each of the users by sending data over the intervening electronic network to each of their portable computing devices. In this way each of a plurality of users is provided the ability to make a suggestion, provide an indication of acceptance or rejection to a suggestion provided by another user, and receive an indication as to the collaborative decision reached based upon the indication of acceptances and/or rejections provided by a plurality of members of the group.

A variety of inventive methods are disclosed by which the provided indications of acceptances or rejections are tallied and a determination is made based as to whether or not the suggestion was collaboratively accepted or rejected. In some embodiments a simple majority is used wherein if a majority of the plurality of users indicate acceptance, the suggestion is accepted. In other embodiments a weighted majority is used wherein each of the plurality of users may have a different weighted impact upon the tally and/or determination of the resulting decision. In some embodiments an acceptance level other than a majority may be required, either weighted or unweighted, for example an acceptance level that exceeds a certain level, percentage, or threshold. In these ways the system may be customized such that the user's acceptance or rejection feedback is inventively considered when determining a collaborative decision made by the group.

A variety of inventive methods are also disclosed for tracking each group member's success rate in posing suggestions to the group (i.e. how often that user's suggestions are accepted collaboratively by the group). The user's success rate in posing suggestions is used, at least in part, in some embodiments, in determining that user's weighting level when that user provides acceptance or rejection feedback to suggestions posed by others. The user's success rate in posing suggestions is also used, at least in part, in some embodiments, in determining that user's priority level, the priority level affecting that user's ability to rate suggestions of other users and/or the frequency with which that user may pose suggestions to the group.

A variety of inventive methods are also disclosed for tracking each groups members accuracy in responding to suggestions posed by others (i.e. how often that user's response to a suggestion matches the computed consensus of the whole group). The user's accuracy in responding to suggestions posed by others is used, at least in part, in some embodiments, in determining that user's weighting level when that user provides acceptance or rejection feedback to suggestions posed by others. The user's accuracy in responding to suggestions posed by others is also used, at least in part, in some embodiments, in determining that user's priority level. In some embodiments, the priority level affects a user's ability to rate suggestions of other users and/or the frequency with which that user may pose suggestions to the group.

In these ways, some embodiments of the present invention provide beneficial features and functions that enable groups of users to more easily make suggestions to the group and collaboratively accept or reject the suggestions.

Some embodiments of the present invention provide a Groupwise Collaborative Suggestion Moderation System that enables the members of a group of individual users of networked portable computing devices to more easily make collaborative decisions about suggestions posed by members of the group. More specifically, some embodiments of the present invention comprise a plurality of networked portable computing devices, each to be used by an individual user, such that one or more of said individual users may pose a suggestion to the group as a textual, verbal, pictorial, and/or video representation. The suggestion may be, for example, a suggestion about a media item that the group should listen to, a place that the group should go to, a restaurant that the group should patronize, a movie that the group should watch, a food that the group should order, another user that the group should allow into the group, a user that the group should kick out of the group, a time that the group should meet, a product that the group should purchase, or a direction the group should go, or other similar suggestions related to decisions that are often made by groups of friends as they socialize together. Some embodiments of the present invention furthermore enable each member of the group to selectively accept or reject the suggestion posed by another member of the group. Some embodiments of the present invention also include methods and apparatus by which a collaborative decision is electronically determined by one or more processors as to whether or not the suggestion has been accepted or rejected by the group. Once such a collaborative decision is electronically determined, an indication as to state and status of the decision is communicated to each of the users by sending data over the intervening electronic network to each of their respective portable computing devices. The state and status of the collaborative decision is then displayed to the user through a user interface of his or her portable computing device. In these ways each of a plurality of users of an Groupwise Collaborative Suggestion Moderation System is provided the ability to (A) pose a suggestion to the group, (B) provide an indication of acceptance or rejection to a suggestion provided by others user of the group, and (C) receive an indication as to the electronically determined collaborative decision that has been generated by one or more processors based upon the plurality of indications of acceptances and/or rejections provided by a plurality of members of the group. Where necessary, computer programs, routines and algorithms are envisioned to be programmed in a high level language, for example Java (TM) C++, C, C#, or Visual Basic™.

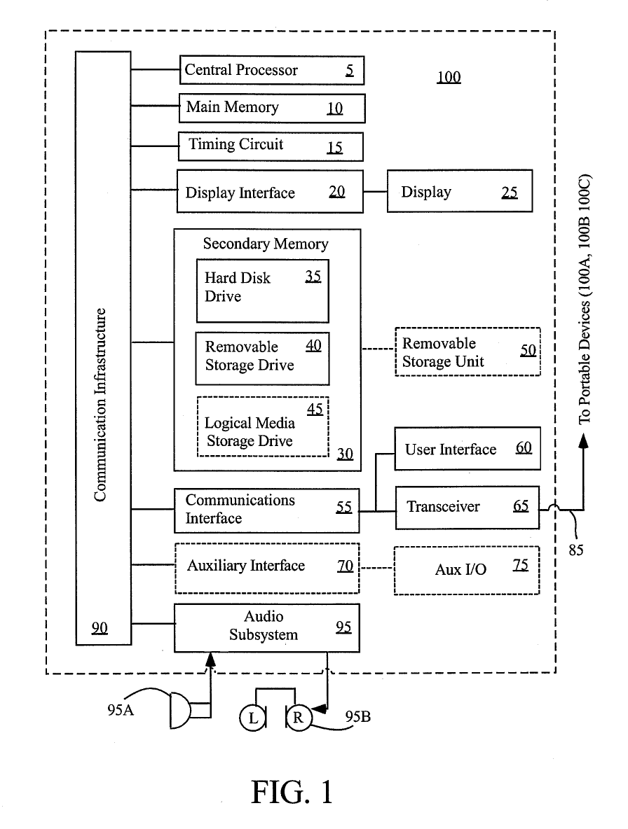

Referring to FIG. 1, a generalized block diagram of a portable computing device 100 is depicted. This device may be embodied as a handheld unit, a pocket housed unit, a body worn unit, or other portable unit that is generally maintained on the person of a user. The portable computing device 100 includes a communications infrastructure 90 used to transfer data, memory addresses where data items are to be found and control signals among the various components and subsystems of the portable computing device 100.

A central processor 5 is provided to interpret and execute logical instructions stored in the main memory 10. The main memory 10 is the primary general purpose storage area for instructions and data to be processed by the central processor 5. The main memory 10 is used in its broadest sense and includes RAM, EEPROM and ROM. A timing circuit 15 is provided to coordinate activities within the portable computing device 100. The central processor 5, main memory 10 and timing circuit 15 are directly coupled to the communications infrastructure 90. The processor may be configured to run a variety of applications, including for example phone and address book applications, media storage and play applications, gaming applications, clock and timing applications, phone and email and text messaging and chat and other communication applications. The processor is also configured to run at least one Groupwise Collaborative Suggestion and Decision Making Application. Such an application may be a stand alone application or may be a component of an application that also runs upon other networked processors.

A display interface 20 is provided upon the portable computing device to drive a display 25 associated with the portable computing device 100. The display interface 20 is electrically coupled to the communications infrastructure 90 and provides signals to the display 25 for visually outputting both graphics and alphanumeric characters. The display interface 20 may include a dedicated graphics processor and memory to support the displaying of graphics intensive media. The display 25 may be of any type (e.g., cathode ray tube, gas plasma) but in most circumstances will usually be a solid state device such as liquid crystal display.

A secondary memory subsystem 30 is provided which houses retrievable storage units such as a hard disk drive 35, a removable storage drive 40, an optional a logical media storage drive 45 and an optional removal storage unit 50.

The removable storage drive 40 may be a replaceable hard drive, optical media storage drive or a solid state flash RAM device. The logical media storage drive 45 may be flash RAM device, EEPROM encoded with playable media, or optical storage media (CD, DVD). The removable storage unit 50 may be logical, optical or of an electromechanical (hard disk) design.

A communications interface 55 subsystem is provided which allows for standardized electrical connection of peripheral devices to the communications infrastructure 90 including, serial, parallel, USB, and Firewire connectivity. For example, a user interface 60 and a transceiver 65 are electrically coupled to the communications infrastructure 90 via the communications interface 55. For purposes of this disclosure, the term user interface 60 includes the hardware and operating software by which a user executes procedures on the portable computing device 100 and the means by which the portable computing device conveys information to the user. The user interface 60 employed on the portable computing device 100 may include a pointing device (not shown) such as a mouse, thumbwheel or track ball, an optional touch screen (not shown); one or more pushbuttons (not shown); one or more sliding or circular rheostat controls (not shown), one or more switches (not shown), and one or more tactile feedback units (not shown); One skilled in the relevant art will appreciate that the user interface devices which are not shown are well known and understood.

To accommodate non-standardized communications interfaces (i.e., proprietary), an optional separate auxiliary interface 70 and auxiliary I/O port 75 are provided to couple proprietary peripheral devices to the communications infrastructure 90.

The transceiver 65 facilitates the remote exchange of data and synchronizing signals between and among a plurality of portable computing devices 100A, 100B, 100C in processing communications with 85 with this portable computing device 100. In this way a group of users, each using one of said plurality of portable computing devices, may engage in a collaborative suggestion and decision making process over an intervening electronic network. The transceiver 65 is envisioned to be of a radio frequency type normally associated with computer networks for example, wireless computer networks based on BlueTooth™ or the various IEEE standards 802.11.sub.x., where x denotes the various present and evolving wireless computing standards. In some embodiments the portable computing devices establish an ad hock network between and among them, as with a BlueTooth communication technology. In other embodiments the portable computing devices establish a network by each accessing a remote server and by exchanging data through the remote server as an intervening entity.

It should be noted that any prevailing wireless communication standard may be employed to enable the plurality of portable computing devices to exchange data and thereby engage in a collaborative suggestion and decision making process. For example, digital cellular communications formats compatible with for example GSM, 3G and evolving cellular communications standards. Both peer-to-peer (PPP) and client-server models are envisioned for implementation of the invention. In a third alternative embodiment, the transceiver 65 may include hybrids of computer communications standards, cellular standards and evolving satellite radio standards.

Lastly, an audio subsystem 95 is provided and electrically coupled to the communications infrastructure 90. The audio subsystem is configured for the playback and recording of digital media, for example, multi or multimedia encoded in any of the exemplary formats MP3, AVI, WAV, MPG, QT, WMA, AIFF, AU, RAM, RA, MOV, MIDI, etc.

The audio subsystem preferably includes a microphone 95A which is used for the detection and capture of vocal utterances from that unit's user. In this way a user may issue a suggestion as a verbal utterance. The portable computing device may then capture the verbal utterance, digitize the utterance, and convey the utterance to other of said plurality of users by sending it to their respective portable computing devices over the intervening network. In this way, a user may convey a suggestion verbally and have the suggestion conveyed as verbal audio content to other users. It should be noted that if the users are in close physical proximity the suggestion may be conveyed verbally without the need for conveying it through an electronic media. A user may simply speak the suggestion to the other members of the group who are in close listening range. Those users may then accept or reject the suggestion using their portable computing devices and taking advantage of the tallying, processing, and electronic decision determination and communication processes disclosed herein. In this way some embodiments of the present invention may act as a supportive supplement that is seamlessly integrated into a direct face to face conversation held among a group of users.

For embodiments that do include a microphone 95A, it may be incorporated within the casing of the portable computing device or may be remotely located elsewhere upon the body of the user and is connected to the portable computing device by a wired or wireless link. Sound signals from microphone 95A are generally captured as analog audio signals and converted to digital form by an analog to digital converter or other similar component and/or process. A digital signal is thereby provided to the processor of the portable computing device, the digital signal representing the audio content captured by microphone 95A. In some embodiments the microphone 95A is local to the headphones or other head-worn component of the user. In some embodiments the microphone is interfaced to the portable computing device by a Bluetooth link. In some embodiments the microphone comprises a plurality of microphone elements.

The audio subsystem generally also includes headphones (or other similar personalized audio presentation units that display audio content to the ears of a user) 95B. The headphones may be connected by wired or wireless connections. In some embodiments the headphones are interfaced to the portable computing device by a Bluetooth communication link.

As referred to in this specification, “media items” refers to video, audio, streaming and any combination thereof. In addition, the audio subsystem is envisioned to optionally include features such as graphic equalization, volume, balance, fading, base and treble controls, surround sound emulation, and noise reduction. One skilled in the relevant art will appreciate that the above cited list of file formats is not intended to be all inclusive.

The portable computing device 100 includes an operating system, the necessary hardware and software drivers necessary to fully utilize the devices coupled to the communications infrastructure 90, media playback and recording applications and at least one Groupwise Collaborative Suggestion and Decision Making Application operatively loaded into main memory 10. Optionally, the portable computing device 100 is envisioned to include at least one remote authentication application, one or more cryptography applications capable of performing symmetric and asymmetric cryptographic functions, and secure messaging software. Optionally, the portable computing device 100 may be disposed in a portable form factor to be carried by a user.

The Groupwise Collaborative Suggestion and Decision Making Application may be architected in a variety of ways to enable a plurality of similarly enable portable computing devices to engage in the collaborative processes described herein. In some embodiments each participating portable computing device acts to both enable its user to provide suggestions and to tally and process the suggestions provided by others. In other embodiments one portable computing device takes on a coordinating role, acting to tally and process the suggestions provided by others and to return the resulting decisions to the other participating users. In some embodiments an external server or other separate processor takes on a coordinating role, acting to tally and process the suggestions provided by the members of a group and to return the resulting decisions to the participating users. In some embodiments a hybrid combination of these methods is used. Regardless of how the processing load is distributed among the portable computing devices and optionally an external server, the Groupwise Collaborative Suggestion and Decision Making Application, when working in combination, a enables the members of a group of individual users of networked portable computing devices to more easily make collaborative decisions about suggestions that are posed by members of the group.

More specifically, the application as disclosed herein enables the user of each of a plurality of networked portable computing devices to selective pose suggestions to the other members of the group as a textual, verbal, pictorial, and/or video representation. Some embodiments of the present invention furthermore enable each member of the group, upon receiving a suggestion, to each selectively accept or reject the suggestion by providing feedback into their respective portable computing device. In some embodiments the acceptance or rejection is a binary decision entered by the user into his or her portable computing device. In other embodiments the acceptance or rejection is a scaled response on a subjective rating scale, the scaled response being entered by the user into his or her portable computing device. In some embodiments the user enters responses manually into his or her portable computing device. In some embodiments the user enters responses verbally into his or her portable computing device. In some embodiments the user enters responses gesturally into his or her portable computing device (for example as a positive or negative head nod). Methods and apparatus for using head nod gestures are disclosed in above-mentioned patent application Ser. No. 11/285,534.

In these ways a first user within a group of users or networked portable computing devices may selectively provide a suggestion to the other users of said group, said other users of said group then may selectively enter an indication of acceptance or rejection the suggestion into his or her portable computing devices. The indications of acceptance or rejection are then passed over an intervening electronic network to at least one processor, optionally a processor of one of the portable computing devices or optionally an external server, such that a tally is compiled as to the level of acceptance and/or rejection collaboratively provided by the plurality of group members. Some embodiments of the present invention also include processing methods by which a final collaborative decision is determined as to whether or not the suggestion has been accepted or rejected by the group based upon the type, quantity, and/or level of indication responses received. Once a collaborative decision is determined based upon the indications received by participating group members, an indication as to state and status of the collaborative decision is then communicated to each of the users by sending data over the intervening electronic network to each of their portable computing devices. The portable computing device then displays the state and/or status of the collaborative decision to its respective user. In these ways each of a plurality of users is provided the ability to make a suggestion, provide an indication of acceptance or rejection to a suggestion provided by another user, and receive an indication as to the collaborative decision reached based upon the indication of acceptances and/or rejections provided by other members of the group.

Collaborative Decision Determination: A variety of inventive methods have been developed by which the acceptances and rejections (as provided by group members in response to a suggestion) are tallied and a determination is made based as to whether or not the suggestion was collaboratively accepted or rejected by the group as a whole. In general a processor receives the acceptances and rejections from the plurality of portable computing devices and stores them in temporary memory. The acceptances and rejections are usually received in relational association with an indicator of which group member (or which portable computing device associated with a particular group member) the acceptance and/or rejection indication originated from. The acceptances and rejections are also usually received in relational association with an indicator of which suggestion it was sent in response to. In some embodiments these relational associations are achieved by assigning or otherwise relating a unique identifier with each user in the group (or each portable computing device associated with a particular user in the group) as well as by assigning a unique identifier to each suggestion posed to the group. In this way a response that originates from a particular portable computing device is sent along with or in relational association with two unique identifiers, one that identifies which user (or device) it originated from and one that identifies which suggestion it relates to. In a common embodiment an acceptance or rejection is sent as a three packet message over a wireless communication link, the first packet indicating the unique ID of the user who gave the response, the second packet indicating the unique ID of the suggestion to which the response relates, and the third packet being a value that indicates the acceptance or rejection of the suggestion as indicated by that group member. The third packet may be a binary indicator wherein 0 indicates rejection and 1 indicates acceptance. The third packet may alternately be an analog value that indicates a level of acceptance or rejection on a subjective rating scale. In this way the three packet message communicates the critical information, including an indication of the user that provided the response, the suggestion to which the response relates, and the degree of acceptance or rejection. In some embodiments additional values may also be communicated, for example an indication of the priority level, weighting value, or other qualification value of the user who provided the response.

By receiving such data from a plurality of portable computing devices of a plurality of group members, a processor of the system stores the values in memory and then tallies them to determine if the groups collective will with respect to each posed suggestion. In general a tally and determination is made separately with respect to each suggestion posed to the group. In general each user is only allowed to contribute one response to each suggestion. In some embodiments if a user provides multiple responses, the last given response is the one used by the tally and determination process. In other embodiments the first response given is the one used. In some embodiments each user's response is weighted equally in the tally and determination process. In other embodiments each users response may be weighted differently based upon a priority level or other preference level associated with the responding user. In some embodiments users are assigned a higher weighting value when their responses are tallied by virtue of having been a member of the group for a longer period of time. In other embodiments a user is assigned a higher weighting value when their responses are tallied by virtue of that user having been determined to be highly accurate in their previous responses (as will be described more later in this document) or by virtue of that user having been determined to be highly successful in their previous suggestions to the group (as will be described more later in this document).

Timing Issues: It should be noted that in some embodiments the tally and determination process is performed for a given suggestion once the processor that is performing the determination process has received an acceptance or rejection indication for that suggestion from all members of a particular defined group. In other embodiments a time limit is placed upon the suggestion such that the tally and determination process is performed for a given suggestion after a certain elapsed time has passed from the time when the suggestion was first posed by the suggesting user. If such a time limit is used, the tally and determination process is generally performed upon those responses that have been received within the time limit. In some embodiments, users who do not provided a response within the time limit are not considered in the tally and determination process. In other embodiments a default value is assumed for those users who did not provide a response within the elapsed time limit. In some such embodiments the default value is set to acceptance. In this way if a user does not respond to a given suggestion within the required time limit, it is assumed that the user accepts the suggestion. Alternately, in some embodiments the default value is set to rejection. In this way if a user does not respond to a given suggestion within the required time limit, it is assumed that the user rejects the suggestion. Whether the no-response default is set to acceptance or rejection is often set as a user-configurable parameter that each user may define upon his or her portable computing device.

In some embodiments the tally and determination process is performed only if two conditions are met, the conditions including (a) at least a minimum number of group members have responded to the suggestion, and (b) a certain minimum elapsed time has passed since the suggestion was posed. This is a highly beneficial method because it ensures that a reasonable number of users have provided a response to the given suggestion and it ensures that all users have been provided sufficient time to provide a response if they cared to do so for a given suggestion. In a common embodiments the minimum number of group members required is set to a percentage, such as 60% and the minimum elapsed time is set to a reasonable time period like 3 minutes. Thus if a user poses a suggestion to a group of friends, suggesting that they “go eat Chinese food,” the responses provided by the group members will not be made until both (a) 70% of the friends have responded, and (b) 3 minutes has elapsed. In addition, those users who do not formally respond with an explicit acceptance or rejection may have configured their devices to provide a default response.

Determination Methods: With respect to the tally and determination process, a number of methods may be used to determine if a suggestion that has been responded to by group members is collaboratively accepted or rejected by the group as a whole. In some embodiments a simple majority is used wherein if a majority of the plurality of users indicate acceptance, the suggestion is accepted. In other embodiments a weighted majority is used wherein each of the plurality of users may have a different weighted impact upon the tally and/or determination of the resulting decision. An example of a weighted determination process is disclosed in the above-mentioned patent application Ser. No. 11/223,368 and Provisional Patent Application No. 60/644,417. In such ways a user may be assigned a priority level or other preference level that causes his or her responses to a suggestion to have a more highly weighted impact upon the tally and determination process than the responses from other users in the plurality of users who have a lower assigned priority level or preference level.

In some embodiments a determination process may be employed such that a suggestion is accepted based upon criteria other than a majority of users indicating acceptance, either as directly counted or as a weighted count. For example an acceptance level that exceeds a certain defined level, percentage, or threshold may be used instead of a simple majority count. In some specific embodiment, the system may be configured to determine that a suggestion is accepted if 80% of the responding group members have indicated acceptance. In an alternate embodiment an acceptance score is computed for a suggestion based upon the weighted response values received from group members. If the score exceeds a certain threshold value, for example exceeds 70% of the total score possible in the weighted tally, the suggestion is accepted. If the score does not exceed the certain define threshold value in the weighted tally, the suggestion is rejected.

Competing Suggestions: In some embodiments of the present invention a group member may respond to an indication that a particular suggestion has been accepted by the group by quickly thereafter posing a competing suggestion to the group. This is a suggestion that is posed to the group as an alternative to the accepted suggestion. For example, a first member of the group may have suggested that the group go out for Italian Food at the current time. This suggestion may have been responded to by a plurality of group members within an allotted time such that the tally and determination process found the suggestion to be accepted by the group. An indication of this acceptance is then communicated to all members of the group over the intervening network connection such that it is displayed to each group member upon their portable computing device. In response to seeing this acceptance, a second group member, presumed one who had rejected the suggestion, may respond by immediately suggesting a competing suggestion to the group. For example, by suggesting to the group that they go out for Chinese Food instead. This competing suggestion is identified by the proposing user, as represented in the coded information sent over the intervening network, as being posed as an alternative to the previously accepted suggestion. In this way the group of users is given the ability to accept or reject the posed competing suggestion as a posed alternative to the previously accepted suggestion. Once the users have sufficiently provided responses to this new competing suggestion, a tally and determination process is employed to determine if this competing suggestion is accepted as a replacement for the previously accepted suggestion. Because this is a competing suggestion, and not just a suggestion in isolation, the routines of some embodiments of the present invention are generally configured to require that the acceptance count or weighted acceptance level that is tallied for the competing suggestion be such that it exceeds the similarly computed acceptance count of weighted acceptance level for the previous suggestion it is competing with. In this way in order for a new suggestion that is posed as a competing suggestion to a previously proposed suggestion to be accepted and thereby replace the previously posed suggestion, it must achieve a higher acceptance level than the previously posed suggestion. In some embodiments an exceed-amount threshold level is set that indicates by how much the competing suggestion must exceed the previously accepted suggestion in order for it to be accepted and thereby replace the previously accepted suggestion. Note—in some embodiments a competing suggestion may only be posed as a possible replacement for a previously accepted suggestion if it is posed within a certain time threshold of the previous acceptance. In this way a suggestion is made final if no competing suggestion is proposed within that certain time threshold. Note—in some embodiments a competing suggestion may only be posed as a possible replacement for a previously accepted suggestion if it is posed by a user who rejected the previously accepted suggestion. In this way a suggestion cannot be competed against by a new suggestion from someone who accepted it. Note—in some embodiments a competing suggestion may only be posed as a possible replacement for a previously accepted suggestion if it is posed by a user who has a priority level or other preference level that exceeds a certain level. In this way a competing suggestion cannot be posed by users who have below a certain level of priority or preference. Note—in some embodiments a competing suggestion may only be posed as a possible replacement for a previously accepted suggestion if it is posed by a user who has a priority level or other preference level that exceeds or optionally matches the priority level of the user who proposed the previously accepted suggestion. In this way a competing suggestion cannot be posed by users who have a priority level that is less than the priority level of the user who posed the previously accepted suggestion. This enables a hierarchy of users who have different suggestion rights and competing suggestion rights.

User Performance Tracking: A variety of inventive methods are also disclosed for tracking each group member's success rate in posing suggestions to the group (i.e. how often that user's suggestions are accepted collaboratively by the group). This value may be called many things, but is referred to here generally as a member's Suggestion Success Rating. A user's suggestion success rating may be computed in a variety of ways but is generally determined such that it indicates or otherwise represents the level of success that the user has achieved when proposing suggestion to the group. For example, in one embodiment the Suggestion Success Rating is determined as a success percentage that indicates the percentage of suggestions proposed by that user to the group that were accepted from within the total number of suggestions posed by that user to the group. Such a value is generally computed as a running total that is updated each time a user makes a new suggestion to the group. This value is generally accessible to the user for display such that the user may keep track of his or her success level when proposing suggestions to the group. In some embodiments a plurality of Suggestion Success Rating values are stored for a given user, one such value that indicates his or her success level across all of the groups that he or she may participate in, and one additional value that is specific only to suggestions posed to each unique group that the user participates in. In some embodiments the rating values are determined uniquely for each new session that is established by a group of participants. In other embodiments the rating values are accrued over a long period of time.

The user's success rate in posing suggestions as determined by that user's Suggestion Success Rating or other similar value, is used at least in part, in some embodiments, in determining that user's weighting level when that user provides acceptance or rejection feedback to suggestions posed by others. For example, if a user has a Suggestion Success Rating that indicates him or her to be highly successful in posing suggestions to the group, the tally and determination routines may be configured such that that user's responses to other's suggestions are more heavily weighted in the tally and determination process than the responses of users who have lower Suggestion Success Ratings. In this inventive way users who are good at providing suggestions have a greater impact upon the acceptance or rejection of suggestions from others. This may be achieved in some embodiments by having a user's Suggestion Success Rating being used, at least in part, in determining that user's priority level or other preference level within the group of users. In some embodiments this usage of Suggestion Success Rating to affect a user's priority level or other preference level may also be used by the routines of some embodiments of the present invention to affect that rate at which and/or the frequency at which that user is allowed to pose suggestions to the group. In this way user's who have higher Suggestion Success Ratings are enabled to provide suggestions to the group with greater frequency than users who have a lower Suggestion Success Rating.

A variety of inventive methods are also disclosed for tracking each groups members accuracy in responding to suggestions posed by others (i.e. how often that user's response to a suggestion matches the computed consensus determined for the whole group with respect to the given suggestion). This value may be called many things, but is referred to here generally as a member's Response Accuracy Rating. A users response accuracy rating may be computed in a variety of ways but is generally determined such that it indicates or otherwise represents how often that the user has provided a response to a suggestion that matched the general consensus (i.e the final acceptance determination) achieved by the group as a whole. For example, in one embodiment the Response Accuracy Rating is determined as a value that indicates the percentage of acceptance and/or rejection responses provided by that user to suggestions posed by other members of a group that matched and/or supported the final acceptance determination determined for the respective suggestions. Thus if a user often provides responses to suggestions that match the acceptance outcome for the group, the user will have a high Response Accuracy Rating. Alternately, if a user often provides responses to suggestions that go against the outcome for the group, that user will have a low Response Accuracy Rating. The value is generally computed as an accuracy percentage as from among the total number of responses provided to suggestions posed by other members. Such a value is generally computed as a running total that is updated each time a user makes a response to a suggestion posed by another member of the group. This value is generally accessible to the user for display such that the user may keep track of his or her accuracy level when responding to suggestions posed to the group. In some embodiments a plurality of Response Accuracy Rating values are stored for a given user, one such value that indicates his or her response accuracy across all of the groups that he or she may participate in, and one additional value that is specific to each unique group that the user participates in. In some embodiments the accuracy values are determined uniquely for each new session that is established by a group of participants. In other embodiments the accuracy values are accrued over a long period of time.

In some embodiments, a user's accuracy rate in responding to suggestions as determined by that user's Response Accuracy Rating or other similar value, is used at least in part, in some embodiments, in determining that user's weighting level when that user provides acceptance or rejection feedback to suggestions posed by others. For example, if a user has a Response Accuracy Rating that indicates him or her to be highly accurate in responding to suggestions from other members of the group, the tally and determination routines may be configured such that that user's responses to other's suggestions are more heavily weighted in the tally and determination process than the responses of users who have lower Response Accuracy Ratings. In this inventive way, users who are good at providing responses to suggestions provided by others (i.e. responses that usually match the collective will of the group) will have a greater impact upon the acceptance or rejection of future suggestions than others. Similarly, users who are poor at providing responses to suggestions provided by others (i.e. responses that usually don't match the collective will of the group) will have a lesser impact upon the acceptance or rejection of future suggestions than others. This may be achieved in some embodiments by having a user's Response Accuracy Rating used, at least in part, in determining that user's priority level or other preference level within the group of users. In some embodiments the Response Accuracy Rating is also used to affect that rate at which and/or the frequency at which that user is allowed to pose suggestions to the group. In this way user's who have higher Response Accuracy Ratings are enabled to provide suggestions to the group with greater frequency than users who have a lower Response Accuracy Ratings.

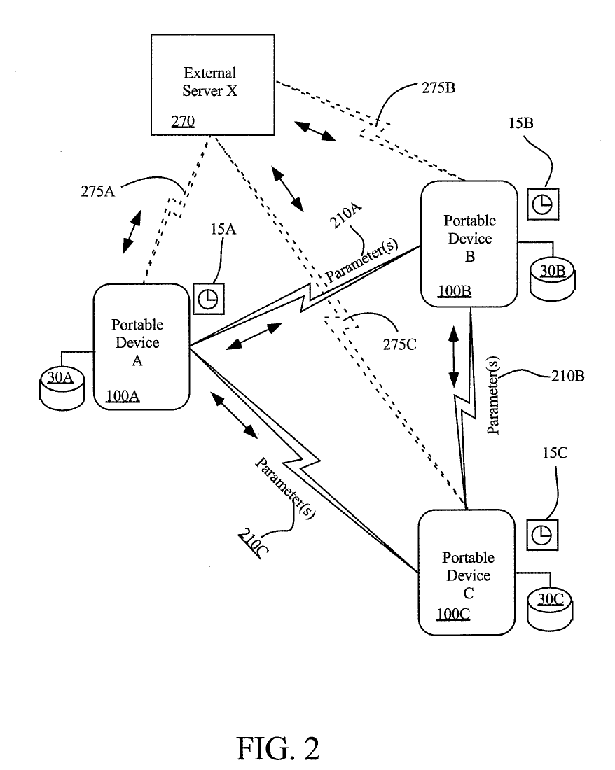

Referring to FIG. 2, an embodiment of the invention is depicted where a plurality of portable computing devices 100A, 100B, 100C are in processing communications with at least another portable computing device to enable their respective user's to collaboratively pose and evaluate suggestions among them and to enable at least one process of the system to tally the responses and make a determination as to the acceptance or rejection of each posed suggestion. The process may be configured where one of the portable computing devices 100A makes a suggestion, as is entered by its user, by sending that suggestion to the other two portable computing devices 100B, 100C in the defined group. The suggestion is conveyed as a coded message exchanged between the three portable computing device using one or more parameters 210A, 210B, 210C. The parameters may be in any form that represents a coded message or value. In some embodiments, the coded message includes a text, voice, pictorial, or video representation of the suggestion along with a unique user ID from which the suggestion came and a unique suggestion ID that identifies the suggestion from other suggestions that have been posed. In some embodiments the suggestion is posed verbally by a user by speaking directly to the other users, the coded message then being sent in substantial time proximity with the verbal speaking. Once a suggestion is conveyed, either by direct speaking or by an electronic communication, each user associated with the portable computing device may accept or reject the posed suggestion by submitting a response regarding the suggestion into their portable computing device. The response is conveyed to a coordinating portable computing device or to a coordinating external server 270, which then tallies the responses and makes a determination as to whether or not the suggestion has been accepted or rejected. The coordinating portable computing device (or external server) may also compile and/or update user statistics such as Response Accuracy Ratings and/or Suggestion Success Ratings for the participating users. The collaborative decision-making is performed by a coordinating portable computing device, which may be the suggesting portable computing device 100A or an external server 270, by using the information contained in the exchanged parameters 210A, 210B, 210C as previously described.

In an embodiment of the invention that employs one or more external servers 270 not part of the collaborating group of portable computing devices A, B or C 100A, 100B, 100C, may act as a third party that receives suggestions from a suggesting party, conveys suggestions to other members of the group, receives responses from group members, tallies and determines the collective will of the group based upon the received feedback (i.e. determines the final acceptance or rejection of the suggestion), and conveys the result of the suggestion determination back to the participating group members.

One skilled in the relevant art will appreciate that the parameters 210A, 210B, 210C may be communicated between and among the portable computing devices A, B or C 100A, 100B, 100C and the External Server 270 using well established communications methods including but not limited to incorporating the parameters 210A, 210B, 210C in a message packet, digital certificate, text string, applications protocol data unit (APDU), binary signal, etc., generally defined by the communications protocol employed. References made in this specification to messaging, signaling, communicating, transmitting, sending, receiving, submitting suggesting, exchanging, notifying, alerting, voting, etc. should be construed in light of the relevant art regarding digital communications, such as communications involving data transfer from one computer to another through a communications medium without regard to a particular format, data structure or communications protocol.

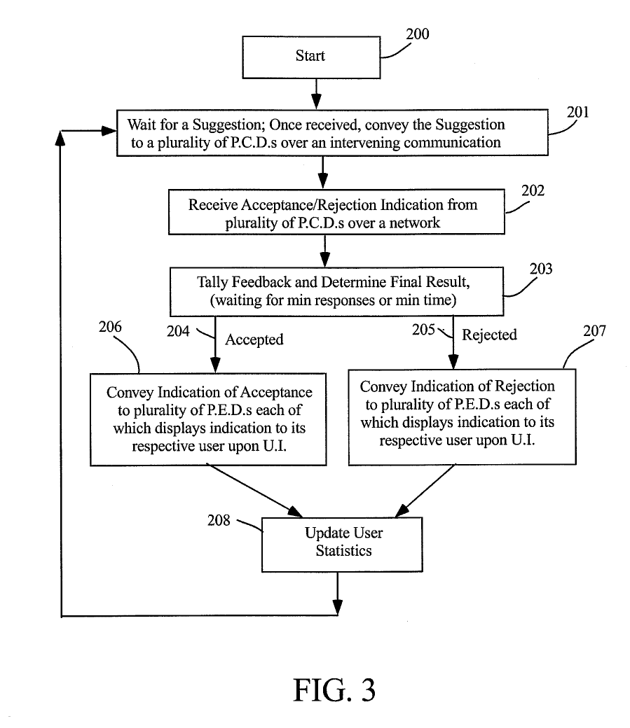

Referring to FIG. 3, shown is an example flow chart of an example program of some embodiments of the present invention. The program flow shown would generally be performed by the parallel operation of routines running upon each of the plurality of portable computing devices used by each of the plurality of users within a collaborative group. In some embodiments routines also run in parallel upon an external server. In addition, the routines running upon the various electronic devices are generally run in parallel with other functions running upon those devices, for example processes that select and/or play media items by accessing media content from memory and outputting an audio representation of such media content through headphones and/or other similar audio presentation hardware. The program flow shown is generally performed, at least in part, by the combined operation one or more programs operatively loaded into main memory 10 of each portable computing device and optionally a program loaded into the memory of a remote server.

The program flow of FIG. 3 begins at step 200, generally in response to a function call or other programming flow construct. Once started, the program flow performs a continuous loop until terminated. The continuous loop includes a number of steps which may be performed in a variety of orders. In the particular flow shown in FIG. 3, the first step in the continuous loop is step 201 wherein the routines of some embodiments of the present invention wait for a suggestion to be received from a member of the group. It should be noted that separate processes have been run already to define and/or configure this particular group of users. In the example embodiment, each in the group of users is using their own portable computing device (P.C.D) equipped with Bluetooth communication capabilities. The devices have formed an ad hock network among them using the Bluetooth protocol. Each user has been defined a unique user ID. Each user has also been assigned a set of user statistics that were initialized to nominal values upon inception of the group session. Thus when step 201 is run, the group of users have already been established, each user having a unique ID and a unique set of user statistics. The user ID and user statistics may be maintained for all users upon one of the portable computing device which acts as a collaboration coordinator, and/or may be maintained upon each user's own portable computing device.

Thus at step 201 the routines of some embodiments of the present invention, either running upon one device that is designated as a collaboration coordinator, or running in parallel upon each user's own portable computing device, wait for a suggestion to be conveyed by a user. This suggestion may be conveyed as a direct verbal communication from a user to the other users. If so, it must be accompanied with a user interface action (such as a button press or menu selection) to indicate that the directly conveyed verbal suggestion is being tracked by the system. Alternately the suggestion is entered directly be a user into his or her respective portable computing device as a textual, verbal, or video signal. Either way, upon the issuance of a suggestion by a user, either directly to the other users or into his or her portable computing device, the routines of some embodiments of the present invention assign that suggestion a unique Suggestion ID, associated that value with the unique User ID of the user who posed the suggestion, and conveys the suggestion and/or the relationally associated values to each of the other user's in the participating group. This occurs by transferring data to the portable computing device of each group member, the data including the Suggestion ID and the unique User ID and for electronically conveyed suggestion embodiments, the actual content of the suggestion.

Once this data has been communicated over the intervening-communication network, the process then proceeds to 202. In this step, the message is displayed to each of the users (unless it was directly conveyed by the suggesting user verbally). This display may be visual or audio through a graphical display and/or speakers. In some embodiments this display is accompanied with the display of an indication of which user the suggestion came from. Thus in some embodiments the suggesting user may be anonymous. In other embodiments the suggesting user is indicated. In some embodiments the suggesting user may configure his or her suggestion to be anonymous or unconcealed. Once the message has been conveyed to the participating users, a time clock is started to determine the elapsed time since the suggestion was made. Step 202 then proceeds by waiting for acceptances or rejection indications to be entered by each user into his or her respective portable computing device and then conveyed over the intervening network to a coordinating device. The coordinating device thus waits to receive the acceptance or rejection indications from the other users. This is generally conveyed as a message that includes an acceptance value (which may be binary or analog) and the unique Suggestion ID to which the acceptance value relates. Also included is the unique User ID of the user who provided that acceptance value. These values are generally stored in memory for at least some period of time.

Once a sufficient number of users have responded and/or once the accrued time since the suggestion was posed has exceeded any required threshold times, the process then proceeds to step 203 wherein the collected acceptance values are tallied and final result is determined. There are a variety of methods by which this tally and determination may be conducted, as described previously, including but not limited to simple majority determinations, weighted determinations, and/or threshold exceeding determinations. If the suggestion is accepted by the group as determined by the determination method, the process proceeds along path 204. If the suggestion is rejected by the group, the process proceeds along path 205. If accepted, step 206 is performed in which an indication of the acceptance is provided to each member of the group. This is generally performed by sending message to the portable computing device of each group member, the portable computing device upon receiving the message, displaying that the suggestion has been accepted. In some embodiments the suggestion itself is displayed along with the indication of acceptance. In some embodiments the degree or level of acceptance is also conveyed and displayed.

If rejected, step 207 is performed in which is performed in which an indication of the rejection is provided to each member of the group. This is generally performed by sending message to the portable computing device of each group member, the portable computing device upon receiving the message, displaying that the suggestion has been rejected. In some embodiments the suggestion itself is displayed along with the indication of rejection. In some embodiments the degree or level of acceptance is also conveyed and displayed.

Once the determination is made as to the acceptance or rejection of the suggestion, the process proceeds to step 208. At this step the user statistics are updated for both the suggesting user and the feedback providing users. More specifically, the Response Accuracy Rating is updated for each feedback providing user and the Suggestion Success Rating is updated for the suggesting user. In addition user priority levels and/or preference levels may be updated based upon the new Response Accuracy Ratings, Suggestion Success Ratings, and/or accrued usage time of each user. In some embodiments a user's priority level and/or preference level may be updated in response to the number and/or frequency of suggestions provided by that user. In some embodiments a user's priority level and/or preference level may be updated in response to the number and/or frequency of suggestions responded to by that user.

After step 208, the process loops back to 201. In this way the system waits for a new suggestion to be provided by a user. It should be noted that the process of waiting for a new suggestion may be a background process that operates in parallel with other function of the portable computing device, for example media playing functions, person to person communication functions, or gamming application functions. In some embodiments the collaborative suggestions posed by the users to the group are directly related to such other functions, for example suggestions related to media to be played synchronously to the group of users such as songs or videos, suggestions for actions or strategies to be taken within a multi-player gaming environment that the group of users are participating in, or suggestions related to a multi-user conversation that the users are maintaining through communication functions of the electronic devices. For example, a group of users engaging the collaborative suggestion and decision making system disclosed herein may be team members who are engaged in a multi-player game and may be using the functions disclosed herein to make collaborative strategic decisions about gaming actions. In this way, a group of users, each using their own portable computing device, may independently play a multi-player gaming application while at the same time may be supported by some embodiments of the present invention in making collaborative decisions based upon suggestions posed by various members of the group.

Finally, it should be noted with respect to FIG. 3, that the flow chart shown may be structured such that multiple such program flows may be operative in parallel wherein a plurality of users are posing suggestions at the same or similar times. In this way a first user may pose a suggestion to the group and be waiting for other users to provide their responses. During that waiting period a second user may pose another suggestion to the group and begin waiting for other users to provide their responses. During the waiting period, a third user may pose a suggestion to the group, etc. In this way, the members of the group may ponder multiple suggestions simultaneously and provide their responses independently to each. Because the suggestions are relationally associated with a unique ID and because the responses are relationally associated to the unique ID of the suggestion it relates to, these interlaced processes can operate without confusion. In general the user interface of the portable computing device of the users is structures such that a user may selectively view all the suggestions that are currently awaiting responses and select a suggestion to respond to using a commonplace menu interface. In some embodiments the listing of pending suggestions are also displayed with the elapsed time remaining within which a user may provide a response. Thus if a particular suggestion must be responded to within five minutes, the amount of time remaining is displayed to the user so he or she can more easily determine which suggestions need to be responded to first if there are more than one pending suggestion. In some such embodiments the pending suggestions are presented as an ordered list to each user, the first items on this list being those suggestions that have the least amount of time left within which a user may respond. In some embodiments the pending suggestions are also listed with an indication of how many users have already responded. This is useful for suggestion methods in which the response period is dependent at least in part upon the number or percentage of responding users. In some such embodiments the pending suggestions are presented to the user as an ordered list, the first items on the list being those suggestions that have received the most responses thus far, the last items on the list being those that have received the least responses. Finally, users are generally presented with an indication upon their display screen as to which suggestions they have responded to and which they have not. In some embodiments an alarm may be configured to alert a user when the time remaining to respond to a suggestion is nearing completion. For example, a one minute warning alarm may issue an alert to a user through his or her portable computing device when it is determined that less than one minute remains in the allowed elapsed time before the responses to that suggestion will be tallied and a final determination will be made. Similarly an alarm may issue an alert to a user when other criteria are nearing completion, such as the requisite number or percentage of responses from group members, that will cause a suggestion to be tallied and a final determination to be made. In these ways a user-may be provided with a final warning that enables the user to provide a response before the period for responses is closed.

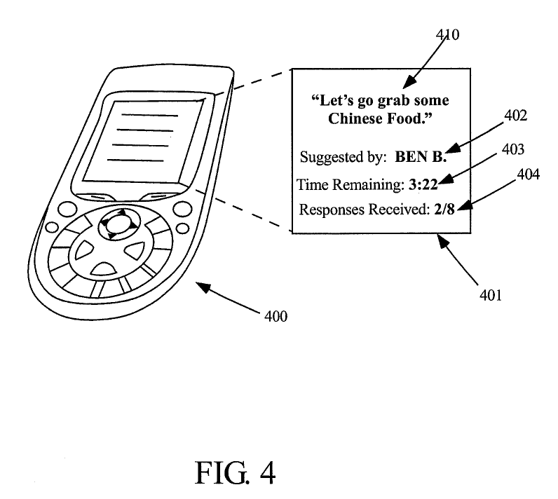

Referring next to FIG. 4, we see an example portable computing device 400 as may be used by a user of the inventive system. The portable computing device 400 includes a visual display screen, a wireless communication link, a processor, user interface buttons, and an audio display. In the example shown, the suggestion is conveyed as a textual string as it was received over said communication link from another computing device. The textual string may have been entered manually by a user of another portable computing device, may have been selected from a listing of prewritten suggestions stored upon said other portable computing device, or may have been uttered verbally by the user of said other portable computing device and converted into a text string by a speech to text conversion routine as is known commonly to the current art. Regardless of how it was generated, in this example the suggestion is received by portable computing device 400 as a textual string and is displayed upon the display screen for viewing by the user. An enlarged sample display of how the textual suggestion is displayed to the user upon the display screen is shown as Enlarged Display 401 in the example figure. As shown on Enlarged Display 401, the suggestion is presented visually as a textual string 410 that reads—“Let's go grab some Chinese Food.” As also shown on the Enlarged Display 401, additional information is displayed along with the textual suggestion, including the name of the suggesting user 402, the time remaining within which to give feedback 403, and the number of responses received thus far from other users 404. In this example the suggesting user is listed as “Ben B.” indicating the name or user name of the user who posed the suggestion. In this example the time remaining is shown as “3:22” which indicates that three minutes and twenty two seconds are left to provide feedback. In this example the number of responses received is listed as “ 2/8” which indicates that 2 users have provided acceptance or rejection responses to the suggestion thus far out of a total of 8 users within the participating group. In this way the user who receives the posed suggestion is informed as to the content of the suggestion, the user who posed the suggestion, the time remaining to provide a response, and the number of users who have responded thus far. In some embodiments an indication of the current acceptance tally may also be displayed.

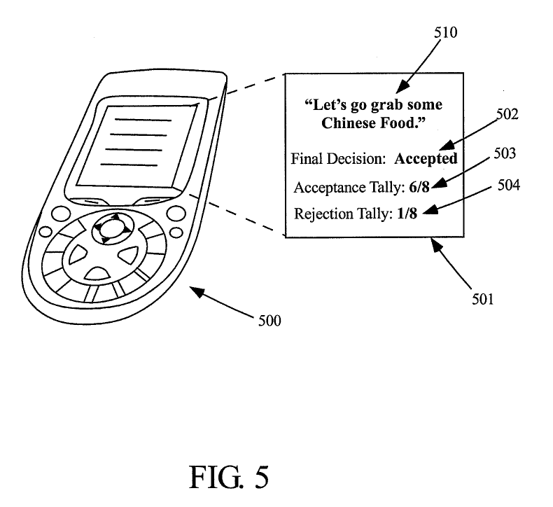

Referring next to FIG. 5 we see an example portable computing device 500 as may be used by a user of the inventive system, after a suggestion has been posed and users have provided their acceptance or rejection responses. In the example shown, the suggestion has been determined by the tally and determination process to have been accepted by the group. An indication of the acceptance is then conveyed to the group members over a communication link. An enlarged sample display of how the indication of acceptance is displayed to the user upon the display screen is shown as Enlarged Display 501 in the example figure. As shown on Enlarged Display 501, the content of the suggestion is presented visually as a textual string 510 that reads—“Let's go grab some Chinese Food.” As also shown on the Enlarged Display 501, additional information is displayed along with the textual suggestion, including the status of the group decision 502, the final tally count of acceptance responses 503, and the final tally count of rejection responses 504. In this example the final group decision is “Accepted” indicating that the tally and determination process has concluded that the suggestion has been accepted by the group. In this example the acceptance tally is shown as “ 6/8” which indicates that six of the eight members of the group accepted the suggestion. In this example the rejection tally is listed as “⅛” which indicates that one of the eight members in the group rejected the suggestion. Note, one user of the group must not have responded. In this way each group member is informed as to the resulting status of the suggestion after the responses are tallied and a determination is made.

As disclosed on the pages herein, a Groupwise Collaborative Suggestion Moderation System is provided that enables the members of a group of individual users of networked portable computing devices to more easily pose suggestions to each other and make computer moderated collaborative decisions as a group.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks. While the invention herein disclosed has been described by means of specific embodiments, examples and applications thereof, numerous modifications and variations could be made thereto by those skilled in the art without departing from the scope of the invention set forth in the claims.

What is claimed is:

1. An automated suggestion moderation system comprising:
a plurality of portable computing devices, a first one of the plurality of portable computing devices adapted to accept a suggestion from a user of the first one of the plurality of portable computing devices via a user interface of the first one of the plurality of portable computing devices and convey an indication of the suggestion to one or more others of the plurality of portable computing devices, each of the one or more others adapted to receive the indication of the suggestion, display a representation of the suggestion at a respective user interface of the one or more others of the plurality of portable computing devices, accept a response to the suggestion from a respective user of the one or more others of the plurality of portable computing devices via the respective user interface, and convey a response indication to a processor,
wherein the processor is adapted to receive a plurality of response indications, generate a decision based at least in part upon the plurality of response indications, and send a decision indication to one or more of the plurality of portable computing devices.

2. The system of claim 1 wherein the processor is comprised within one or more of the plurality of portable computing devices.

3. The system of claim 1 wherein the processor is comprised within one or more external servers.

4. The system of claim 1 wherein the response indication comprises an indication of an acceptance or a rejection of the suggestion.

5. The system of claim 1 wherein the processor is adapted to generate the decision based at least in part upon a tally of the plurality of response indications.

6. The system of claim 1 wherein the processor is adapted to generate the decision based at least in part upon a majority of the plurality of response indications being acceptance indications.

7. The system of claim 1 wherein the processor is adapted to generate the decision based at least in part upon a percentage of acceptance indications being greater than a value.

8. The system of claim 1 wherein the processor is adapted to generate the decision based at least in part upon a weighted tally of the plurality of response indications, wherein a first one of the plurality of response indications has a greater effect upon the decision than a second one of the plurality of response indications.

9. The system of claim 1 wherein the suggestion indicates a piece of musical media suggested to be played upon at least one of the plurality of portable computing devices.

10. The system of claim 9 wherein the decision comprises at least one of an acceptance or a rejection of the play of the suggested piece of musical media.

11. The system of claim 1 wherein the decision is generated as an acceptance of the suggestion when more than a predetermined percentage of the plurality of response indications are acceptance indications.

12. The system of claim 1 wherein the decision is generated as an acceptance of the suggestion when a majority of the plurality of response indications are acceptance indications.

13. The system of claim 1 wherein the decision is generated as an acceptance of the suggestion when all of the plurality of response indications received are acceptance indications, thereby representing a unanimous set of received affirmative responses.

14. The system of claim 1 wherein the response is a value on a rating scale that indicates a level of acceptance of the suggestion by the respective user.

15. The system of claim 1 wherein the response is provided by the respective user as input that is manual, verbal, or gestural.

16. The system of claim 1 wherein the processor generates the decision based at least in part upon one or more default responses, each of the one or more default responses being generated in response to one of the respective users of the one or more others of the plurality of portable computing devices failing to input a respective response to the suggestion within a predetermined time limit.

17. The system of claim 1 wherein at least one of the plurality of the portable computing devices displays a representation of the decision indication upon a screen of the at least one of the plurality of the portable computing devices.

18. The system of claim 1 wherein at least one of the plurality of the portable computing devices displays a representation of a response tally upon a screen of the at least one of the plurality of the portable computing devices.

19. The system of claim 1 wherein each of the one or more others of the plurality of portable computing devices is further adapted to display an indication of the user who provided the suggestion to the first one of the portable computing devices.

20. The system of claim 19 wherein the indication of the user is at least one of a name, handle, electronic address, or unique ID of the user of the first one of the portable computing devices.

21. The system of claim 1 wherein each of the one or more others of the portable computing devices is further adapted to display an indication of an amount of time remaining during which the respective user may indicate the response.

22. A method for automated collaborative decision making comprising:
receiving an indication of a suggestion, the indication of the suggestion being generated in response to user input into a first portable computing device;
conveying a representation of the suggestion to a plurality of other portable computing devices over a wireless communication network;
causing at least a portion of the representation of the suggestion to be displayed through an output of each of the plurality of other portable computing devices such that the at least a portion of the representation of the suggestion may be reviewed by a respective user of the each of the plurality of other portable computing devices;
providing a limited time period during which the respective user may provide a response to the suggestion by interacting with a respective user interface of the each of the plurality of other portable computing devices;
receiving an indication of the response from one or more of the plurality of other portable computing devices;
producing a tally of the indication of the response of the one or more of the plurality of other portable computing devices;
generating a decision based at least in part upon the tally; and
sending an indication of the decision to at least one of the plurality of other portable computing devices.

23. The method of claim 22 wherein the indication of the response is an indication of an acceptance or rejection of the suggestion.

24. The method of claim 22 wherein a default response is assigned as the response of the at least one of the plurality of other portable computing devices, the default response being assigned as a result of no response being entered into the at least one of the plurality of other portable computing devices during the limited time period.

25. The method of claim 24 wherein the default response is a rejection response.

26. The method of claim 22 wherein the conveying step is performed by the first portable computing device.

27. The method of claim 22 wherein the conveying step is performed by an external server.

28. The method of claim 22 wherein the tally comprises, at least in part, the number of acceptance indications received in response to the suggestion.

29. The method of claim 22 wherein the step of generating the decision is performed based at least in part on a determination that a majority of the indications of the responses are an indication of acceptance.

30. The method of claim 22 wherein the step of generating the decision is performed based at least in part on a determination that more than a threshold percentage of the indications of the responses are an indication of acceptance.

31. The method of claim 22 wherein the step of producing the tally comprises computing a weighted tally in which a first response has a greater effect upon the decision than a second response.

32. The method of claim 22 wherein the indication of the suggestion represents a suggested piece of musical media for play.

33. The method of claim 32 wherein at least one of the indications of responses is an acceptance or rejection of the play of the suggested piece of musical media.

34. The method of claim 22 wherein each of the indications of the responses comprises at least one rating value on a subjective rating scale.

35. The method of claim 22 wherein the user input is at least one of manual or verbal.

36. The method of claim 22 further comprising displaying on a screen of the one or more of the plurality of other portable computing device, an indication of an amount of time remaining during which the respective user of the portable computing device may provide the response.

37. The method of claim 22 wherein the decision is not generated until after the limited time period has expired.

38. A method for automated collaborative decision making comprising:
enabling a plurality of portable computing devices to each display a suggestion to a user of a respective one of the plurality of portable computing devices, at least a portion of the suggestion originating from a first portable computing device as a result of a user interaction with a user interface of the first portable computing device;
receiving a response from each of one or more of the plurality of portable computing devices, each response indicating a degree of acceptance or rejection of the suggestion by the user of the respective portable computing device, the each response being generated as the result of a respective user interaction with a respective user interface of the portable computing device or as the result of a default response process;
generating an acceptance or rejection decision based at least in part upon an assessment of the received responses; and
sending an indication of the decision to the one or more of the plurality of portable computing devices.

39. The method of claim 38 wherein the default response process assigns an automated rejection response when no user response is provided regarding the suggestion through the user interface of the portable computing device within an allotted time.

40. The method of claim 38 wherein the assessment of the received plurality of responses includes, at least in part, a determination when a number of acceptance responses is greater than a predetermined value.

41. The method of claim 38 wherein the assessment of the received plurality of responses includes, at least in part, a determination when a percentage of acceptance responses is greater than a predetermined value.

42. The method of claim 38 wherein the assessment of the received plurality of responses includes, at least in part, a determination when a tally of response values is greater than a predetermined value.

43. The method of claim 38 wherein the assessment of the received plurality of responses includes, at least in part, a determination that all of the received responses are acceptance responses.

44. The method of claim 38 wherein each of the plurality of portable computing devices is assigned a turn as the first portable computing device, thereby enabling each of a plurality of users to provide a separate suggestion to a group of users.
